(19) United States
(12) Patent Application Publication
(10) Pub. No.: US 2024/0300303 A1
(43) Pub. Date: Sep. 12, 2024

(54) AUTOMOTIVE DOOR WINDOW CONVERSION KIT AND METHOD

(71) Applicant: One Piece Products, Whittier, CA (US)

(72) Inventor: BENJAMIN TAPIA, Pico Rivera, CA (US)

(73) Assignee: One Piece Products, Whittier, CA (US)

(21) Appl. No.: 18/119,676

(22) Filed: Mar. 9, 2023

(51) Int. Cl. B60J 1/17; B60J 5/04

(52) U.S. Cl. CPC B60J 1/17; B60J 5/0463

(57) ABSTRACT

A door window conversion kit for automotive vehicles, such as Chevy C-10 trucks, includes improved components. In particular, the kit includes a modified glass shape, a modified vertical guide and roller guide having a specific mount that includes custom mounting points for attachment to the vehicle. In addition, the kit includes felted run channels, and beltline scrapers that extend the width of the door glass both outside and inside the door, which include door attachment clips.

### TECHNICAL FIELD

The various embodiments disclosed herein relate to automotive windows. Particularly, the various embodiments disclosed herein relate to automotive door window conversion kits. More particularly, the various embodiments disclosed herein relate to conversion kits for replacing the two-piece door windows of Chevy C-10 model trucks manufactured by General Motors with a single window.

### BACKGROUND

Automotive vehicle enthusiasts and hobbyists appreciate and enjoy the process of customizing their vehicles to not only enhance their aesthetic appearance, but also in some cases, to improve the overall function and performance of the vehicle as well. The process is also personally satisfying because it allows the owner to make the vehicle uniquely theirs and one of a kind. In the case of Chevy C-10 model trucks manufactured by General Motors between 1973 and 1991, it has become highly desirable to replace the original OEM (original equipment manufacturer) door glass window sections, which suffer from various functional and aesthetic issues. In particular, the OEM door windows utilized by these vehicles incorporate a two-piece vent window in addition to the main window, which creates a cluttered and unattractive appearance. Furthermore, the windows utilized by Chevy C-10 doors suffer from manufacturing design variances, which prevent smooth movement of the window within the window frame. In addition, such Chevy C-10 door windows utilize OEM front vertical guides that tend to be unstable, and as a result, impart increased friction and impede window movement. Moreover, the Chevy C-10 door windows utilize aesthetically unpleasing beltline scrapers, which detract from the overall appearance of the vehicle. Thus, completing a door window conversion on the Chevy C-10 improves the function and quality of the original OEM door windows and associated hardware, while increasing the overall aesthetic attractiveness of the vehicle.

However, in order to replace such OEM windows, it requires the assistance of a professional or other highly skilled individual that is knowledgeable in window conversion kits, and the technical details of automotive repair to carry out the window conversion. Because of the limited number of capable window conversion professionals and their high cost, there exists a substantially high barrier to entry for automotive enthusiasts to overcome in order to have a window conversion completed for their Chevy C-10 vehicle.

Accordingly, there is a need for a do-it-yourself (DIY) automotive window conversion kit for Chevy C-10 trucks of the model years 1973 to 1991, which is configured to allow one to readily convert and replace the two-piece OEM Chevy C-10 door window (vent and main windows) with a new single-piece door window that is more aesthetically pleasing. In addition, there is a need for an automotive window conversion kit for Chevy C-10 trucks of the model years 1973 to 1991 that provides a variety of operational and structural improvements that allows the single-piece window conversion to have increased reliability and operational life.

### SUMMARY

In light of the foregoing, it is a first aspect of the various embodiments disclosed herein to provide a window conversion kit for a vehicle door having a window frame comprising an extension section, wherein the extension section has a first end and a second end, wherein the first end has a first aperture so the first end can be attached to a rear vertical guide of the vehicle door, wherein the second end has a second aperture configured to be attached to an original hole on the door where a rear vertical guide was originally fastened; a replacement window glass configured to be slideably received in a window frame provided by the door; at least one attachment bracket configured to be attached to the replacement window glass; at least one guide channel, wherein the guide channel is configured to be attached to the attachment bracket, the at least one guide channel including a channel; at least one slide member configured to be slideably received in the channel, and the slide member configured to be pivotably attached to one or more pivot members of a window actuator of the vehicle; a spacer configured to be inserted in a stacked arrangement at a position of the window frame proximate to the location of where an original vent window was removed; and instructions describing how to convert the original vehicle door having a vent window and a main window to have a one-piece window using extension section, the replacement window, and the spacer.

It is another aspect of the various embodiments disclosed herein to provide a window conversion kit for a vehicle door having a window frame comprising an extension section, wherein the extension section has a first end and a second end, wherein the first end has a first aperture so the first end can be attached to a rear vertical guide of the vehicle door, wherein the second end has a second aperture configured to be attached to an original hole on the door where a rear vertical guide was originally fastened; a replacement window glass configured to be slideably received in a window frame provided by the door; at least one attachment bracket configured to be attached to the replacement window glass; at least one guide channel, wherein the guide channel is configured to be attached to the attachment bracket, the at least one guide channel including a channel; at least one slide member configured to be slideably received in the channel, and the slide member configured to be pivotably attached to one or more pivot members of a window actuator of the vehicle; at least one run channel, wherein the run channel includes a cushioned section; and instructions describing how to convert the original vehicle door having a vent window and a main window to have a one-piece window using the extension section, the replacement window, and the spacer.

### BRIEF DESCRIPTION OF THE DRAWINGS

The various embodiments disclosed herein will become better understood with regard to the following description, accompanying drawings, and claims wherein:

FIG. 1 is a perspective view of an original stock two-piece window of the OEM Chevy C-10 vehicle;

FIG. 2 is a perspective view of a window conversion kit in accordance with the various concepts disclosed herein;

FIG. 2A is a perspective view of a front main guide and guide channel in accordance with the various concepts disclosed herein;

FIG. 3 is a view of the installation procedure which removes the original door panel;

FIG. 4 is a view of the installation procedure which removes screws from the original vent window assembly;

FIG. 5 is a view of the installation procedure showing the removal of the last bolt which allows the removal of the original vent window assembly;

FIG. 6 is a view of the installation procedure showing the removal of the original stock vent window assembly by lowering the original stock window all the way down before withdrawing the original stock vent assembly;

FIG. 7 is a view of the installation procedure showing the original main door glass being raised all the way up to align the rollers with the notches on the stock window glass;

FIG. 8 is a view of the installation procedure with the original rollers detached from the stock window glass and depicting the removal of the original main door glass;

FIG. 9 is a view of the installation procedure showing the removal of the original stock window scrapers;

FIG. 10 is a view of the installation procedure showing the removal of the original rear vertical guide from the vehicle door;

FIG. 11 is a view of the installation procedure showing the installation of an extension section provided by the kit;

FIG. 12 is a view of the installation procedure showing the result of cutting the door lock cylinder which is necessary in order to allow the one-piece window glass to avoid hitting the door lock cylinder;

FIG. 13 is a view of the installation procedure showing the use of a template supplied in the present invention which marks where new holes for the one-piece window conversion have to be drilled into the door;

FIG. 14 is a view of the installation procedure showing the use of a template supplied in the present invention which marks where new holes for the one-piece window conversion have to be drilled into the door;

FIG. 15 is a view of the installation procedure showing the elongation of the hole as made in FIG. 12 by using a drill bit which provides for window adjustment;

FIG. 16 is a view showing a guide channel attached to a window regulator;

FIG. 17 is a view of the installation procedure for the inner and outer scrapers;

FIG. 18 is a view showing the installation of the spacers;

FIG. 19 is another view showing the installation of the spacers;

FIG. 20 is a view showing the installation of the window glass; and

FIG. 21 is a view showing the completed installation of the single piece window glass.

### DETAILED DESCRIPTION

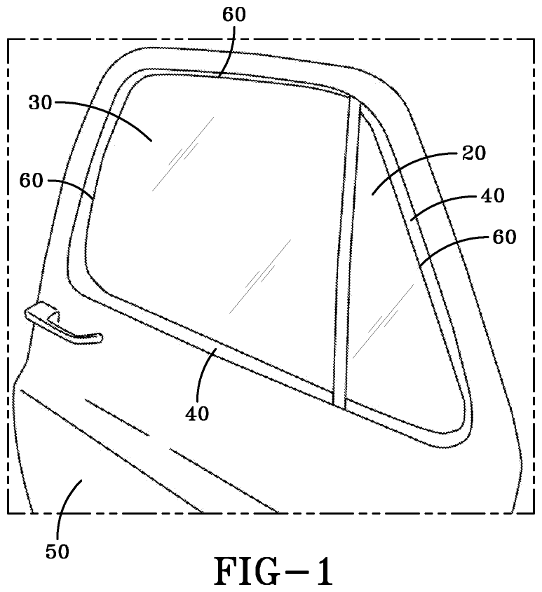

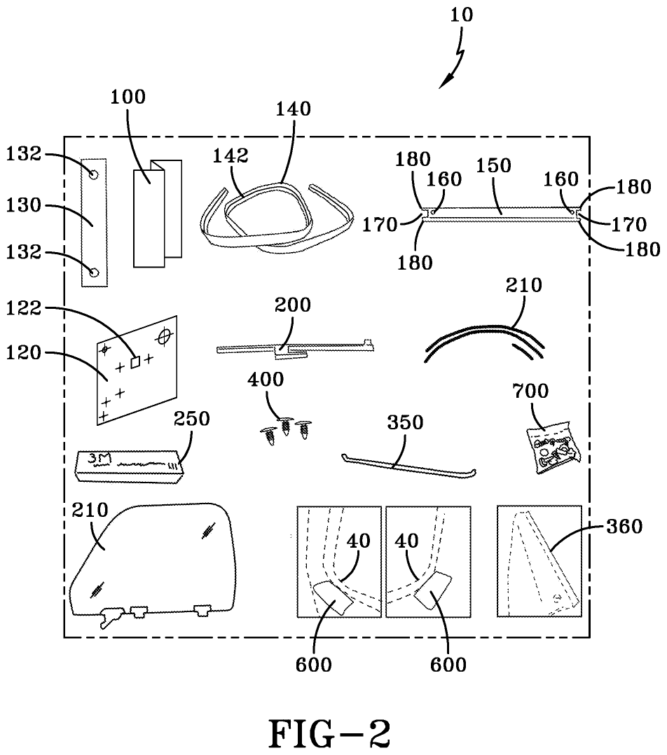

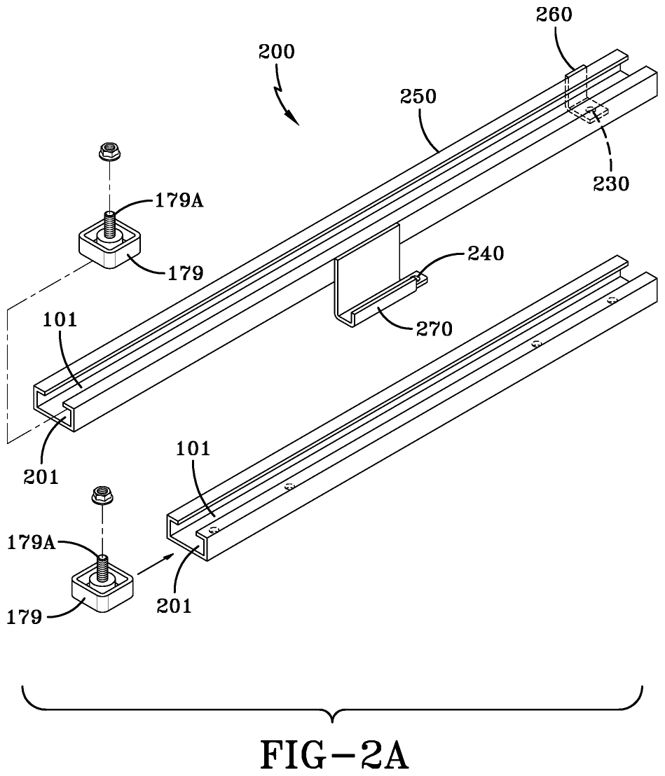

The various embodiments disclosed herein set forth a one-piece window conversion kit 10, as shown in FIG. 2, that is configured to replace the two-piece original OEM (original equipment manufacturer) vent window 20 and main window 30 that is slidably provided within a frame or opening 40 of the driver and passenger side doors 50 (only one door is shown for brevity) of any compatible vehicle, as shown in FIG. 1. However, it should be appreciated that the window conversion kit 10 disclosed herein is discussed as being used to replace the vent window 20 and door window 30 of a Chevy C-10 model truck having a model year from 1973 to 1991 manufactured by General Motors, as shown in the Figs.

Specifically, the window conversion kit 10 includes the following components, as shown in FIG. 2:

### 1. Instructions 100:

In one embodiment of the kit 10, instructions 100 may be provided, which include a description of the manner for removing the OEM door windows (vent and main windows) and/or a description of the manner for installing the window conversion kit 10, and/or various components of the kit 10. In some embodiments, the instructions 100 may be provided on a printed medium, or may be accessed remotely, such as through a website or software application. In other embodiments, the instructions may not be included in the kit 10.

### 2. Hole Template 120:

The kit 10 includes a hole template or guide 120 that is used to locate the position of one or more holes on the interior of each of the doors 50 of the vehicle. The hole template 120 in some embodiments identifies 3 holes that are to be bored into the interior of the doors of the vehicle, such as by the use of a drill. The template 120 may be made from paper, plastic, cardboard, fabric, tape, or any other suitable material. It should also be appreciated that the hole template 120 may not be included in the kit 10, but rather the positional location (i.e., positional dimensions) of where the holes that are to be bored into the doors of the vehicle may be included in the instructions 10. It should be appreciated that the kit may include hole templates or guides 120 for both the driver and passenger side doors 50. In addition, the template 120 may include a hole 122 therethrough that is configured to be aligned with the actuator shaft for the window rolling mechanism of the vehicle, so that the holes of the template 120 to be bored into the interior of the door 50 are properly aligned and positioned.

### 3. An Extension Section 130:

The kit 10 also includes an extension section 130, which is used to push back the original rear guide rail of the vehicle door 50 so that it is closer to the door latch. The extension section 130 is an elongated piece of material, which has an aperture 132 positioned near each end of its length. It should be appreciated that the extension section 130 may comprise any suitable material, such as plastic or metal for example. In some embodiments, the extension section 130 may have a length of approximately 4 inches. The kit 10 includes at least 2 extension sections 130, one for each vehicle door. In further embodiments, the extension section 130 comprises an adjustable section, whose length can be adjusted by the installer.

### 4. Run Channel 140:

The kit 10 also includes a run channel 140, which is used to replace the existing OEM (original equipment manufacturer) run channel. The run channel 140 is configured to fit along an edge 60 of the window opening 40 of the doors 50 and provides a groove 142 to receive the edge of the one-piece window glass 210 therein. Specifically, the run channel 140 may be formed of any suitable material, such as rubber, or other polymeric material. In addition, the groove 142 of the run channel 140 is covered with a surface treatment or other soft material (cushioned section), such as felt or microfiber for example, which is softer than the material used to form the core of the run channel 140. For example, the run channel 140 may include a core that is formed by plastic or rubber, which has a surface that is treated with a material that is softer than the core, such as felt or microfiber material. In some embodiments, the felt material may cover the portions of the groove 142 and/or the areas proximate to the groove 142. In addition, in some embodiments the surface treatment is, soft material, covers the area proximate to the groove 142, and in some cases the walls and/or the base of the groove 142. The groove 142 is configured to receive an edge of the door glass. It should be appreciated that the run channel 140 may include a cushioned material, such as felted material or other soft material, such as microfiber, that is positioned proximate to the window 210.

The kit includes at least 2 run channels 140, one run channel for each door.

### 5. Guide Channel 150:

The kit 10 also includes a guide channel 150, which is used to replace the existing OEM guide channel. The guide channel 150 includes two apertures 160 disposed on each end. In addition, ends of the guide channel 150 include a gap 170 that is formed by spaced tabs 180. It should be appreciated that the tabs 180 are configured to fold down. The guide channel 150 mounts between door glass brackets and the rollers on the window regulator to be described in detail below. It should be appreciated that the guide channel 150 may be formed by any suitable material, such as metal or plastic for example. It should be appreciated that the guide channel 150 includes a channel 101 that comprises a substantially rectilinear cross section. In some embodiments, the cross-section may comprise a square or a rectangle for example. Slidably disposed within the channel 101 of the guide channel 150 are slide members 179, which are attached to the ends 189A and 189B of the scissor members. The slide members 179 are configured as substantially rectilinear in shape and may be formed from any suitable material, such as plastic for example. The slide members 179 also include a mounting aperture 179A to receive a fastener, such as a threaded screw for pivotable attachment to the pivot members 189X and 189Y of the window actuator 189.

The kit includes at least 2 guide channels 150.

### 6. Front Main Guide 200:

The kit 10 also includes a front main guide 200, which is used to guide the front portion of the new window glass 210 into a vertical motion that is parallel with the back guide to be discussed in detail below. The kit 10 includes at least two front main guides 200, which may also be referred to herein as front vertical guides 200. It should be appreciated that the front main guide 200 may be formed of any suitable material, such as metal or plastic for example. The guide 200 includes a channel 201 that has any suitable cross-sectional shape, such as a rectilinear shape, including a square or rectangular shape for example. As shown in FIG. 2A, the front main guide 200 is provided, which includes an upper mounting aperture 230 and a lower mounting aperture 240, which extend from the main guide section 250. Specifically, the upper and the lower mounting apertures 230, 240 are spaced apart. In some embodiments, the upper mounting aperture 230 may extend from the main guide section 250 by an extension section 260, while the lower mounting aperture 240 may extend from the main guide section 250 by an offset section 270. Thus, in some embodiments, the upper mounting aperture 230 and the lower mounting aperture 240 are spaced from the main guide section 250 at different distances. For example, in some embodiments, the upper mounting aperture 230 is spaced from the main guide section 250 by a smaller distance than the lower mounting aperture 240. Overall, the upper and the lower mounting apertures 230 and 240 are configured to allow for the mounting of the front main guide 200 to the inner door panel 800 using suitable fasteners, such as nuts and bolts.

In particular, the kit 10 was configured so that the front main guide or rollers control the manner in which the glass moves up and down.

The kit includes at least 2 front main guides 150.

### 7. Spacer 210:

The kit 10 also includes a spacer 210 that is used to fill the open space or gap that remains when the OEM vent glass 20 is removed from the door 50. The spacer 210 is configured to be stacked upon each other. In some embodiments, the spacer 210 may be formed from rubber, foam, or any other suitable material. In some embodiments, the spacer 210 may be provided in predetermined lengths. In other embodiments, the spacer 210 may be a single length, which is cut by the installer to a desired size. Furthermore, the spacer 210 may be formed of any suitable material, such as rubber, plastic, or fabric for example, or any combination thereof.

The kit includes at least 2 sets of spacers 210.

### 8. Adhesive 250:

The kit 10 also includes adhesive 250, which is used to adhere various pieces of the kit 10 to the door 50, including the felt sections 600 to be discussed and the outer and inner scraper assemblies 350 and 360 including the spacer 210. In some embodiments, the adhesive 250 comprises a liquid adhesive, but may be a gel or paste for example.

It should be appreciated that the kit 10 may not include the trim adhesive 250, but rather may be provided by the installer separately.

### 9. Plugs 400:

The kit 10 also includes plugs 400 that are used to cap off the original holes left by the OEM vent glass 20 and main glass 30 assemblies 20 that were removed from the door 50. In some embodiments, the plugs 400 may be formed of plastic, but may comprise any suitable material. In some cases, the plugs 400 are adhered to the holes using the trim adhesive 250. It should be appreciated that in some embodiments, the plugs 400 may not be provided by the kit 10.

### 10. Outside Window Scraper 350:

The kit 10 also includes an outer window scraper 350, which is used to replace the OEM outer scraper of the OEM door 50 that are removed. The outside scraper 350 is configured to be adhesively attached to the exterior of the door panel 50. It should be appreciated that the outside scraper 350 is configured to have a profile or shape that matches or follows the contour or shape of the door 50.

It should be appreciated that the outside window scraper may include a cushioned material, such as felted material or other soft material, such as microfiber, that is positioned proximate to the window 210. It should be appreciated that the kit 10 includes at least two outside scrapers 350.

### 11. Inside Window Scrapers 360:

The kit 10 also includes an inside window scraper 360 that is mounted to the inside of the door panel 50 to reduce or prevent the rattling of the replacement window 210. It should be appreciated that the inside scraper 350 is configured to have a profile or shape that matches or follows the contour or shape of the door 50. It should be appreciated that the inside window scraper may include a cushioned material, such as felted material or other soft material, such as microfiber, that is positioned proximate to the window 210.

It should be appreciated that the kit 10 includes at least two inside window scrapers 360 are provided.

### 12. Window Glass 210:

The kit 10 also includes a pane of window glass 210 that replaces the OEM two-piece window, which includes the vent glass 20 and the main glass 30. It should be appreciated that the new window glass 210 may also include brackets (not shown). It should be appreciated that the glass 210 is configured with the

It should be appreciated that the kit 10 includes at least two glass 210 sections.

### 13. Felt Tape 600:

The kit 10 also includes felt tape 600, which is used on the inside corners of the window frame 40 of the door 50 that are one the inside surface of the door 50 to prevent any scratches from occurring during installation. In some embodiments, the felt tape 600 may be provided in predetermined lengths or may be provided in one length that is to be cut by the installer to size.

It should be appreciated that the kit 10 includes felt tap 600 for each of the two doors 50 of the vehicle.

### 14. Installation Hardware 700:

Installation hardware 700 includes one or more nuts, bolts, washers, and expansion nuts, suitable for installing the kit 10, in the manner to be discussed. It should be appreciated that the kit 10 includes the necessary hardware 700 for installing two windows.

It should be appreciated that while the components of the kit 10 described above indicates that 2 sets of components are provided to replace the vent and main glass 20 and 30 of both the driver and passenger side doors 50, the kit 10 may include the components necessary to replace the window of only one of the driver or passenger doors 50.

It should also be appreciated that in some embodiments, the kit 10 includes at least the window glass 210, spacer 140, and extension section 130. And in further embodiments the kit 10 includes at least the window glass 210, spacer 140, and extension section 130.

It should also be appreciated that the kit 10 may be configured to include only a subset of the items listed, such as only one or more of the items listed above.

### Method of Use of the Kit:

### 1. Tools:

In order to utilize the kit, one or more of the tools are used by the installer. Specifically, the tools may include:
1. A hammer;
2. A hole saw driven by a drill;
3. Phillips screwdriver;
4. Flat screwdriver;
5. A nut driver or ratchet and a crescent wrench;
6. Drill bit;
7. Rivet gun;
8. Metal saw (e.g. hacksaw); and
9. Grinder.

### 2. Disassembly of Door:

In order to install the kit 10, the following process is under taken:

### A. Vent Window Assembly Removal

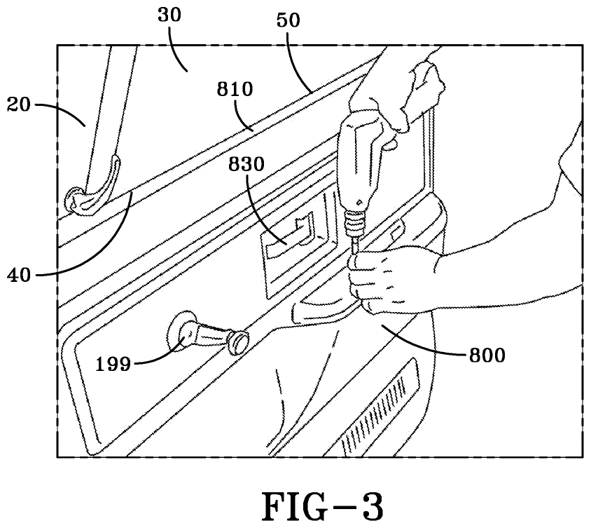

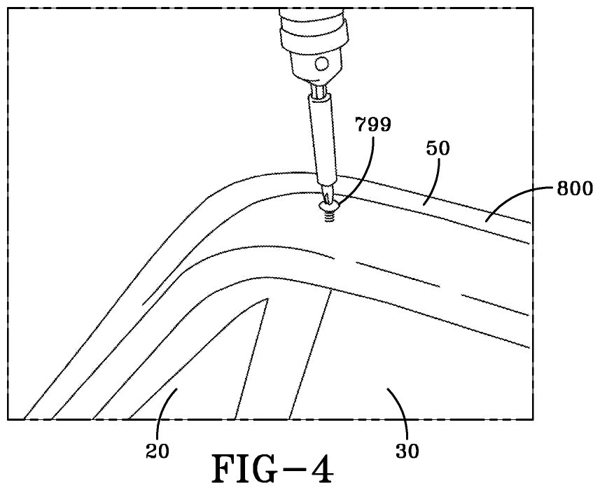

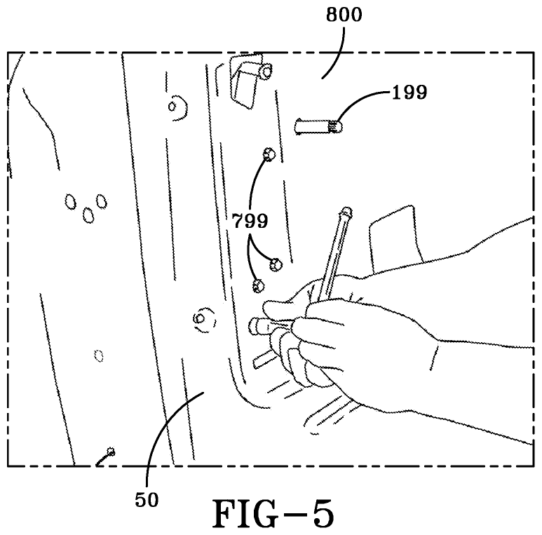

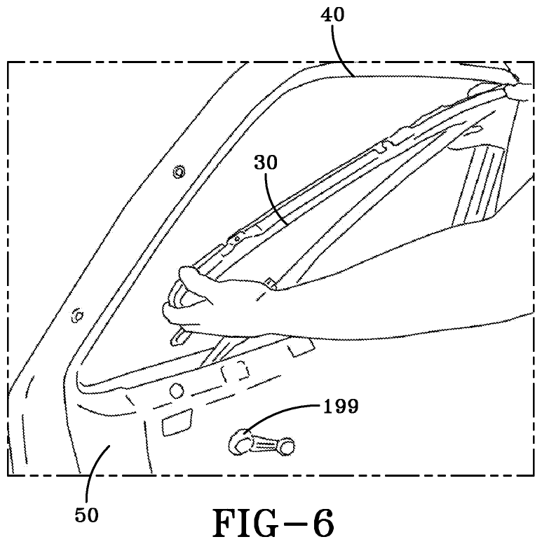

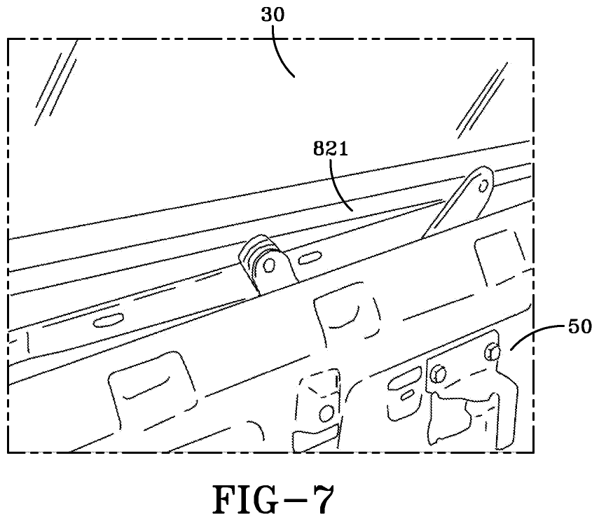

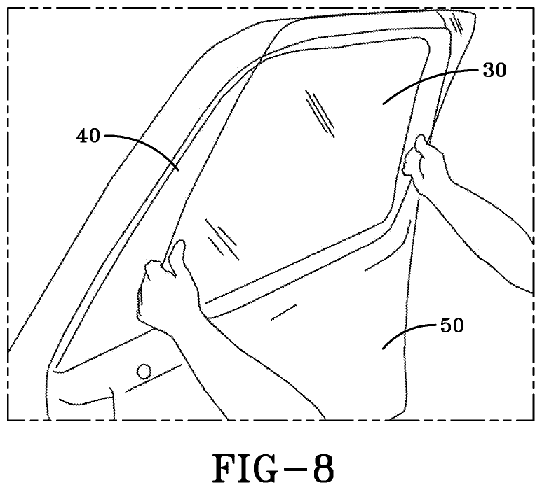

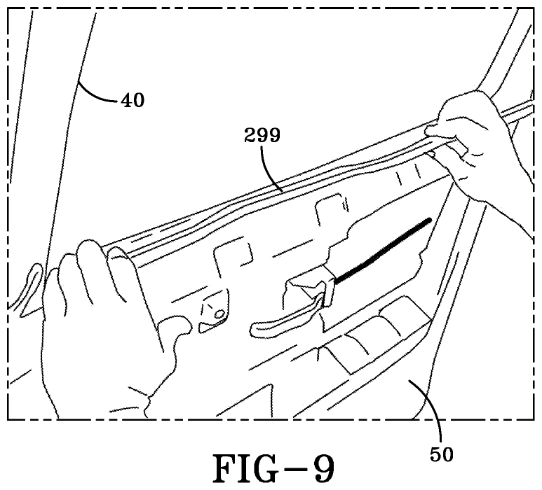

i. As shown, in FIGS. 3-5, in order to remove the vent window 20, the screws 799 attaching an inner door panel 800 of the door 50 are removed, as shown in FIGS. 3 and 4;
ii. In addition, a C-clip of a door handle is removed. In some specific models, one or more vent glass 30 assembly screws 799 that are exposed on the external portion of the vent glass 30 assembly may also need to be removed, as shown in FIG. 4;
iii. As shown in FIG. 5, once the inner door panel 800 is removed, 2 fasteners are exposed near the bottom of the door panel 800 near the vent glass 30 assembly, which requires removal.
iv. Positioned near a spring located at the bottom of the vent glass frame pivot point is a fastener, which also requires removal;
v. Vent glass assembly removal: As shown in FIG. 6, once the fasteners are removed, the vent glass 20 window assembly is permitted to be moved to a bottom position, whereupon the entire vent window assembly 20 can be removed from the door frame 50. It may be required that in order to remove the vent window assembly 20, the main door glass 40 must be in the bottom or retracted position.
vi. Main door glass removal: After the vent glass 20 window assembly is removed at step v., the main door glass 30 is removed. This is completed by rolling up the main door glass 30, such as by actuating the window crank shaft 199, so that the door glass is at the top position where the metal guide channel 820 is in direct view, as shown in FIG. 7. Next, the door glass 30 is slid forward until the door glass is completely removed, as shown in FIG. 8.
vii. Felt and Scraper removal: After the vent glass 20 assembly and main door glass 30 assemblies have been removed, all old felt linings and inner and outer scrapers 299 that remain on the door 50 are to be removed, as shown in FIG. 9.

### 3. Installation of Vent Glass and Main Glass of Kit 10:

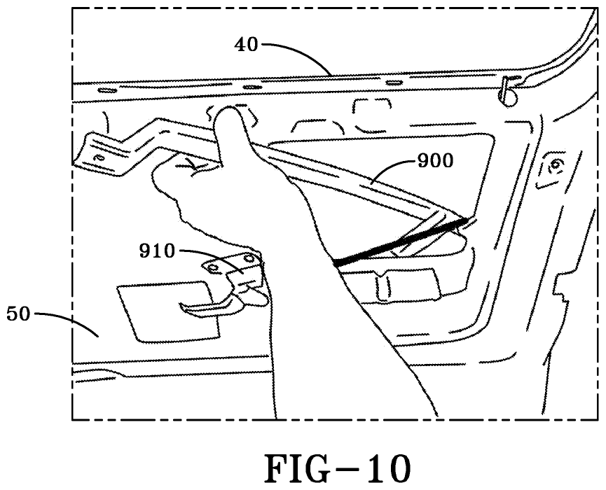

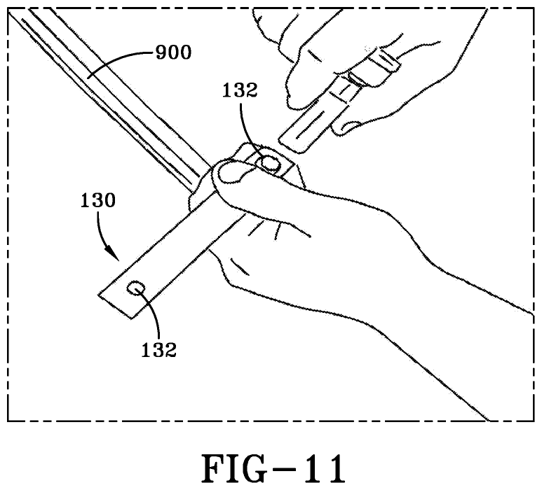

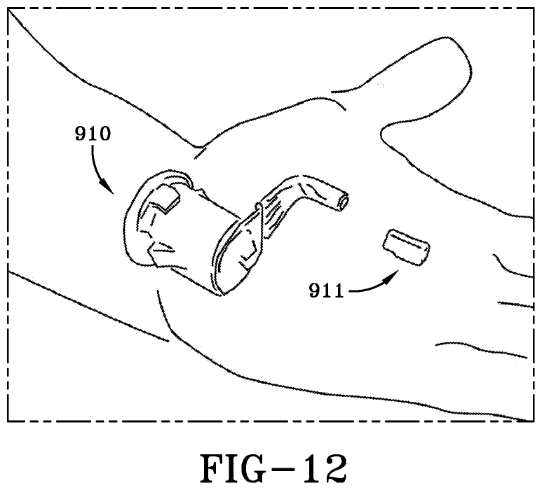

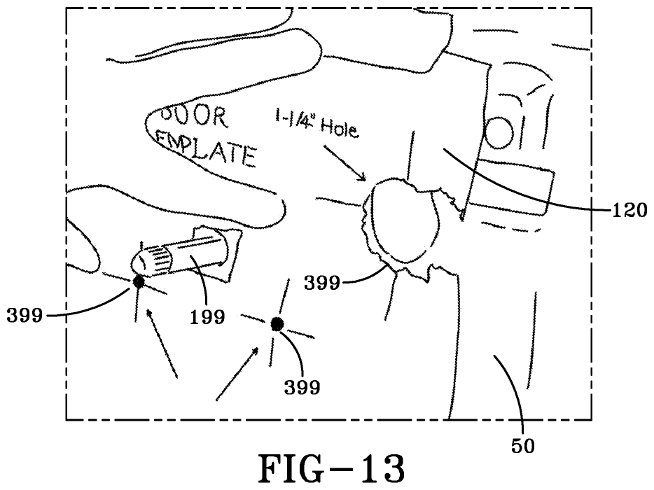

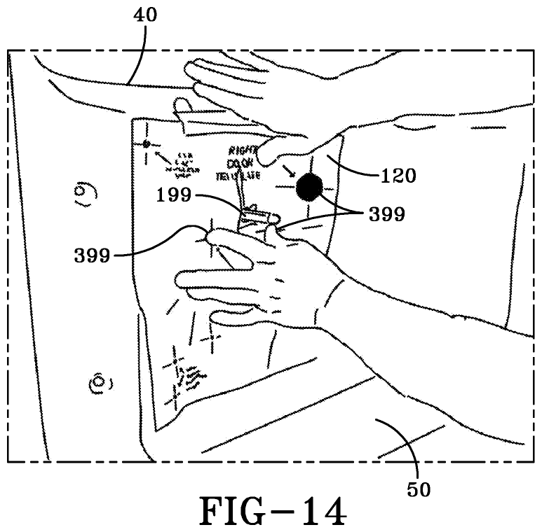

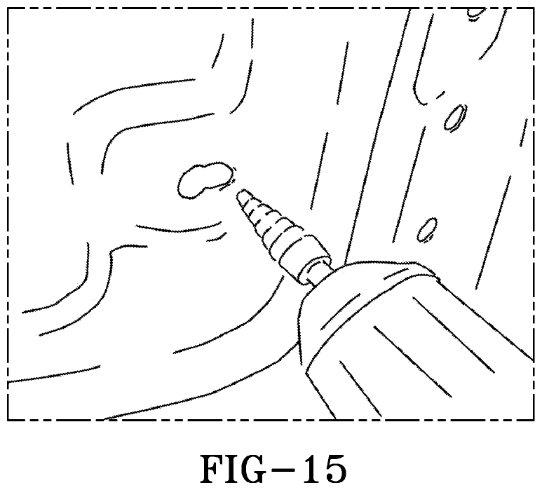

In order to install the kit 10, the following steps are performed:
viii. Rear vertical guide removal: As shown in FIG. 10, a rear vertical guide 900 for the main door glass 30 is also removed. The rear vertical guide 900 is positioned next to a latch assembly 910 of the door frame 50.
ix. Attaching extension section: Once the rear vertical guide 900 is removed, the extension section 130 is attached to the end of the vertical guide 900 hat is distal to the door window opening 40, as shown in FIG. 11. The extension section 130 includes an aperture 132 that is configured to align with the original aperture to which the rear vertical guide 900 was attached. The extension section 130 serves to position the rear vertical guide 900 closer to the door latch assembly 910. In some embodiments, this hole may be slotted by the installer to allow for future adjustment.
x. Roller Installation: In some cases, the window glass regulator assembly requires removal if the existing OEM rollers 179 require replacement with the new rollers. In some embodiments, new rollers are included in the kit.
xi. Door Lock Tumbler Cutting: A tip portion of an elbow that engages the door latch assembly 910 is cut in order to remove it out of the way of the vertical movement of the window glass during operation. In some embodiments, the tip of the door lock tumbler may be cut by approximately 0.5″, as shown in FIG. 12, which depicts the removed section 911.
xii. Hole bore template: Using the hole template 120 provided by the kit 10, shown in FIGS. 13-14, 3 holes 399 whose position is identified by the template 120 are bored into the inner surface of the door frame 50. Specifically, the template 120 includes 4 template positioning holes that are to be aligned with 4 existing holes provided by the manual window regulator assembly. After the 3 new holes 399 identified by the template 120 are bored into the inner surface of the door frame 50, the holes 399 may be elongated, as shown in FIG. 15.

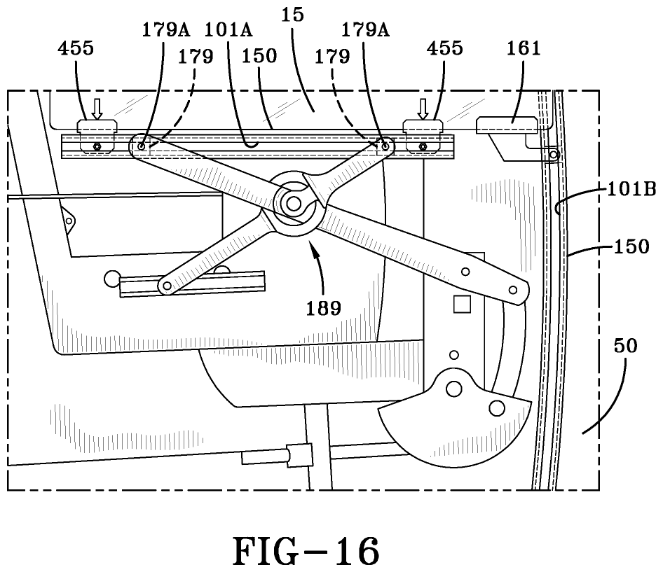

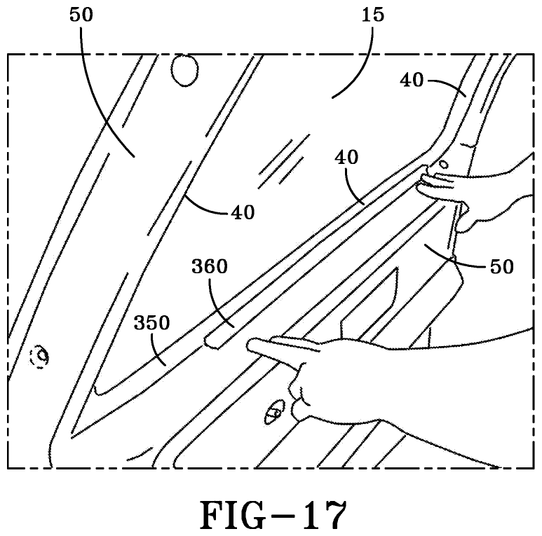

A reinforcement support that is provided by the door frame 50, which crosses the lower horizontal opening is cut, such as by a hacksaw. In some cases, the door 50 is weakened due to this cutting. To mitigate this, a straight bar of metal, such as a 1″×¼″ bar may be used. However, any other metal bar of suitable dimension may be utilized. To attach the bar, a suitable adhesive, such as JB WELD brand, may be used to attach the bar to the inside edge of where the new scraper mounts. Alternatively, the straight bar may be welded in place.
xiii. Grinding inside hinge compression nut: In some cases, an inside hinge nut that is pressed on the door frame needs to be ground flat. That is, in some vehicles, the OEM inner hinge nut that is pressed on the door is too long and will hit or contact the new main glass 210 that is installed from the kit 10. For example, the new main glass 210 may strike the OEM inner hinge nut when the main glass 210 is lowered down. In addition, the kit 10, may optionally include one or more shorter screws or bolts that prevents this from occurring.
xiv. Guide channel installation: As shown in FIG. 16, the new guide channel 150 provided by the kit 10 is attached to the door 50, by inserting the rollers 179 of the window actuator 189 in the channel provided by the guide channel 150. It should be appreciated that the existing window actuator 189 of the vehicle is reused. As such, the window actuator 189 includes 2 pivot members 189X and 189Y which are pivotably joined. In addition, the pivot members 189X and 189Y include upper pivot points, 189A and 189B, as well as 2 lower pivot points 189C and 189D. The upper pivot points 189A and 189B are pivotably attached to the slide members 179A and 179B by suitable fasteners 179C, such as a threaded screw. The lower pivot points 189C and 189D are movably or pivotably attached to the door 50. As such, the slide members 179A and 179B are configured to slide within the channel 101 of the channel member 150, as the pivot members 189X and 189Y move, by a suitable drive member, such as a window crank mechanism or other electrical drive system to raise or lower the window glass 210.
xv. Plastic plug installation: The plastic plugs 400 provided by the kit 10 are used to cover the original holes that remain by the removed vent and main glass assemblies 20 and 30.
xvi. Installation of inner and outer scrapers, the felt assemblies and vent spacer: The inner and outer scrapers 360, 350 and the felt assemblies 600 are positioned proximate to the opening 40 of the doors 50, as shown in FIG. 2. In addition, the inner and outer scrapers 360, 350 are attached at the positions proximate to the window frame opening 40 where the old OEM inner and outer scrapers and felt assemblies were provided, as shown in FIG. 17.

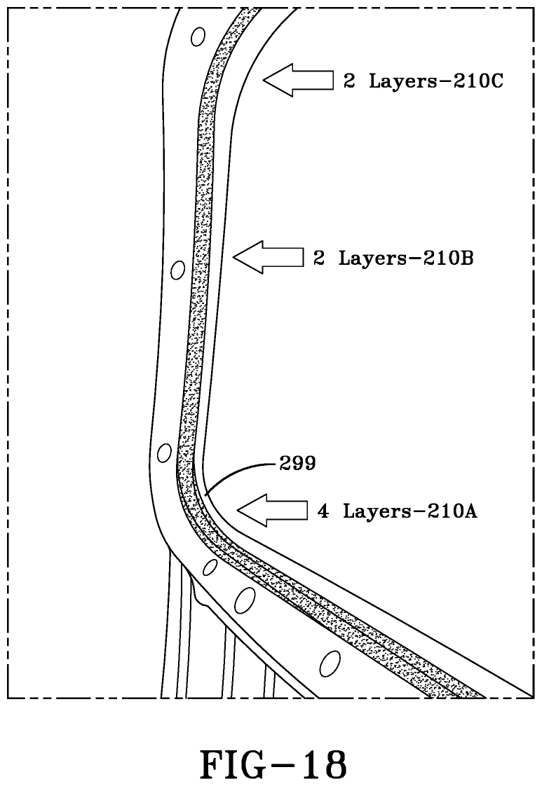

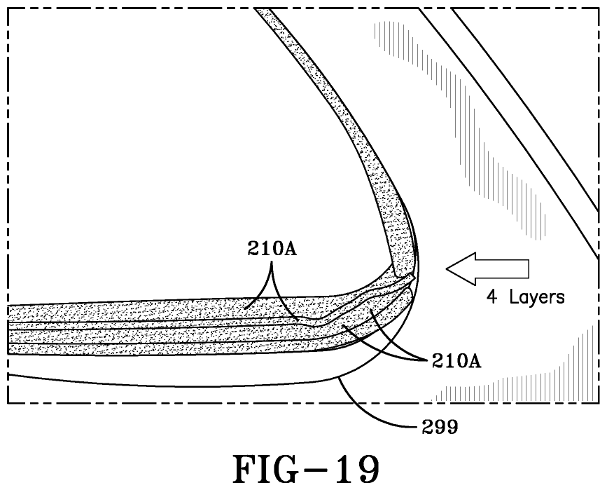

In addition, as shown in FIGS. 18 and 19, the vent spacer 210, which may comprise multiple sections of material are cut, or may be provided in predetermined lengths in the kit 10. In particular, the bottom vent spacer 210A that are positioned proximate to the bottom corner nearest the horizontal curve where the vent glass 30 assembly was previously installed, includes 4 layers of stacked spacers, which are cut to be about 4″ inches in length, but may be any suitable length. In addition, a middle vent spacer 210B and an upper vent spacer 210C include 2 layers of stacked spacers, which are cut to be about 7″ in length, but may be any suitable length. It should be appreciated that these spacers 210A-C are secured using the adhesive 250. It should also be appreciated that spacers 210A-C may be of any desired number of stacked layers.

### XVII. Run Channel Installation:

Next, after the spacers A-C are installed, the new run channel 140 is inserted in the channel of the window opening 40 of the door body 50. The run channel 140 is secured by the adhesive 250.

### XVIII. Outer Scraper Installation:

Continuing, the outer scraper 350 is installed into the glass run channels that extend around the door frame 40. Once installed, the scraper 350 is attached to the door frame 50 using the adhesive 250, as shown in FIG. 17.

### XIX. New Hinge Bolts Installation:

Next, the 2 OEM hinge bolts are removed, and are replaced with the shorter bolts provided by the kit 10. The bolts provided by the kit 10 are shorter than the OEM bolts, and as such do to contact the new window when it is moved or rolled down to open the window. This step is optional.

### XX. Installing Felt Tape:

The felt tape 600, which has adhesive backing is then attached to the inner surface of the door 50 at a position near the bottom of the frame 40 where the vent glass 20 was removed, as shown in FIG. 2.

### XXI. Window Glass Installation:

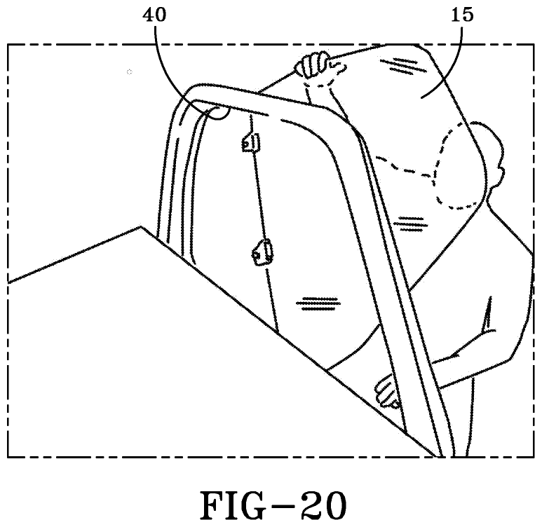

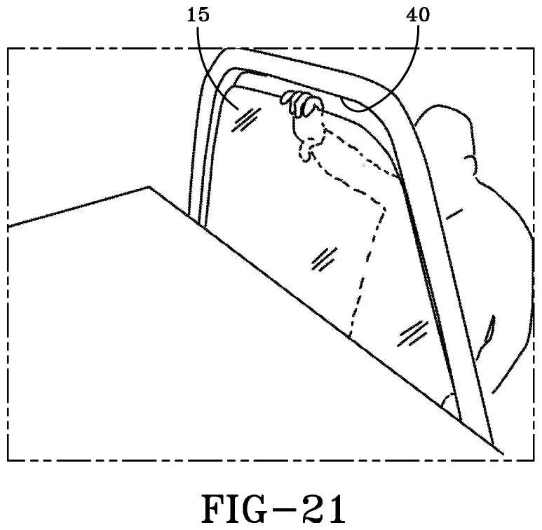

Next, as shown in FIGS. 20 and 21, a hole is bored in the inner surface of the door 50. The hole is approximately, 1.5 inches. This hole is approximately 3″ from the original crank hole in the direction of the lock. In addition, the glass 210 is attached to the guide channel 150 by one or more attachment brackets 455. The attachment brackets 455 are attached to the bottom edge of the window glass 210 by any suitable adhesive, such a glue or tape for example. The attachment brackets 455 are attached at another point to the guide channel 150, such as by a fastener, such as a threaded screw that is secured to the aperture 160 of the guide channel 150.

### XXII. Front Vertical Guide Installation:

Ensuring that the holes are bored into the body of the door 50 according to the template 120. The glass 210 should be in the up position. Next, the front vertical guide 200, as previously discussed, is slid into position, and the mounting bolts received in the upper and lower mounting apertures 230 and 240 of the front vertical guide 200 are tightened. As such, the front vertical guide 200 is secured to the door 50. In addition, the front guide 161 which is attached to the bottom edge of the window glass 210 is inserted in the channel 201. As a result, the installation is completed.

Therefore, it can be seen that the objects of the various embodiments disclosed herein have been satisfied by the structure and its method for use presented above. While in accordance with the Patent Statutes, only the best mode and preferred embodiments have been presented and described in detail, with it being understood that the embodiments disclosed herein are not limited thereto or thereby. Accordingly, for an appreciation of the true scope and breadth of the embodiments, reference should be made to the following claims.

What is claimed is:

1. A window conversion kit for a vehicle door having a window frame comprising:
an extension section, wherein the extension section has a first end and a second end, wherein the first end has a first aperture so the first end can be attached to a rear vertical guide of the vehicle door, wherein the second end has a second aperture configured to be attached to an original hole on the door where a rear vertical guide was originally fastened;
a replacement window glass configured to be slideably received in a window frame provided by the door;
at least one attachment bracket configured to be attached to said replacement window glass;
at least one guide channel, wherein the guide channel is configured to be attached to said attachment bracket, said at least one guide channel including a channel;
at least one slide member configured to be slideably received in said channel, and said slide member configured to be pivotably attached to one or more pivot members of a window actuator of the vehicle;
a spacer configured to be inserted in a stacked arrangement at a position of the window frame proximate to the location of where an original vent window was removed; and
instructions describing how to convert the original vehicle door having a vent window and a main window to have a one-piece window using said extension section, said replacement window, and said spacer.

2. The kit of claim 1, wherein the extension section is approximately 4 inches long.

3. The kit of claim 1, wherein the spacer comprises a plurality of spacer sections.

4. The kit of claim 1, wherein the instruction describes removal of a vent window assembly from the original truck door;
wherein the instruction describes modification of an existing door lock assembly, wherein a consumer is instructed to shorten an original elbow piece of the door lock assembly; and
a paper template within the packaging, wherein the template has marks indicating where new holes is to be drilled on a door structure, when the paper template is placed over the door.

5. The kit of claim 1 further comprising at least one run channel, wherein the run channel includes a cushioned section.

6. The kit of claim 1 further comprising at least one guide channel, wherein the guide channel has apertures positioned proximate its terminal ends.

7. The kit of claim 1 further comprising at least one front guide capable of guiding the window glass as the window glass moves in a vertical motion.

8. The kit of claim 4, further comprising at least one outside scraper, at least one inside door panel scraper, a plurality of plugs, and a plurality of fasteners.

9. The kit of claim 1, wherein said at least one slide member has a rectilinear cross-sectional shape.

10. A window conversion kit for a vehicle door having a window frame comprising:
an extension section, wherein the extension section has a first end and a second end, wherein the first end has a first aperture so the first end can be attached to a rear vertical guide of the vehicle door, wherein the second end has a second aperture configured to be attached to an original hole on the door where a rear vertical guide was originally fastened;
a replacement window glass configured to be slideably received in a window frame provided by the door;
at least one attachment bracket configured to be attached to said replacement window glass;
at least one guide channel, wherein the guide channel is configured to be attached to said attachment bracket, said at least one guide channel including a channel;
at least one slide member configured to be slideably received in said channel, and said slide member configured to be pivotably attached to one or more pivot members of a window actuator of the vehicle;
at least one run channel, wherein the run channel includes a cushioned section; and
instructions describing how to convert the original vehicle door having a vent window and a main window to have a one-piece window using said extension section, said replacement window, and said spacer.

11. The kit of claim 10, wherein the extension section is approximately 4 inches long.

12. The kit of claim 10, further comprising a spacer configured to be inserted in a stacked arrangement at a position of the window frame proximate to the location of where an original vent window was removed.

13. The kit of claim 1, wherein the instruction describes removal of a vent window assembly from the original truck door;
wherein the instruction describes modification of an existing door lock assembly, wherein a consumer is instructed to shorten an original elbow piece of the door lock assembly;
a paper template within the packaging, wherein the template has marks indicating where new holes is to be drilled on a door structure, when the paper template is placed over the door structure.

14. The kit of claim 10 further comprising a spacer configured to be inserted in a stacked arrangement at a position of the window frame proximate to the location of where an original vent window was removed.

15. The kit of claim 10, wherein the guide channel has apertures positioned proximate its terminal ends.

16. The kit of claim 10 further comprising at least one front guide capable of guiding the window glass as the window glass moves in a vertical motion.

17. The kit of claim 16, further comprising at least one outside scraper, at least one inside door panel scraper, a plurality of plugs, and a plurality of fasteners.

18. The kit of claim 10, wherein said at least one slide member has a rectilinear cross-sectional shape.
